(19) United States
(12) Patent Application Publication
(10) Pub. No.: US 2014/0090533 A1
(43) Pub. Date: Apr. 3, 2014

(54) DIE CUTTING SYSTEM

(71) Applicants: Joseph Thomas Calmese, Saint Louis, MO (US); Bradley Edward Hedrick, Saint Clair, MO (US); William Allen McCroskey, House Springs, MO (US); Brian Douglas Stewart, Maryland Heights, MO (US); Kevin Neal Furmanek, Manchester, MO (US); Steven Carl Weinberg, Saint Peters, MO (US); Jeffrey Lee Feltz, Wildwood, MO (US)

(72) Inventors: Joseph Thomas Calmese, Saint Louis, MO (US); Bradley Edward Hedrick, Saint Clair, MO (US); William Allen McCroskey, House Springs, MO (US); Brian Douglas Stewart, Maryland Heights, MO (US); Kevin Neal Furmanek, Manchester, MO (US); Steven Carl Weinberg, Saint Peters, MO (US); Jeffrey Lee Feltz, Wildwood, MO (US)

(73) Assignee: MARK ANDY, INC., CHESTERFIELD, MO (US)

(21) Appl. No.: 14/021,981

(22) Filed: Sep. 9, 2013

Related U.S. Application Data
(60) Provisional application No. 61/698,570, filed on Sep. 8, 2012.

(51) Int. Cl. B26D 1/40

(52) U.S. Cl. CPC B26D 1/405
USPC 83/344

(57) ABSTRACT

A rotary die cutting system includes a die cutting roll having at least one blade thereon for cutting a web, and an indicator on the surface of the die cutting roll indicating the position of the at least one blade. An anvil roll, spaced from the die cutting roll defines a web path therebeween. A drive mechanism drives the die cutting roll. A first sensor senses the indicator on the surface of the die cutting roll, and a control, responsive to the first sensor, operates the drive mechanism to adjust the rotational position of the die cutting roll to align the die cutting roll relative to the web passing through the web path.

### BACKGROUND

This invention relates to die cutting, and in particular to a die cutting system that automatically aligns the die cutting blades for cutting a web.

Current die cutting systems for cutting printed webs must be set up and manually aligned relative to the web, so that the cuts made are properly aligned with the printed images on the web. This process can be tedious and time consuming, and can result in significant waste until the die is properly aligned with the web. Moreover the process must be repeated each time the job changes.

### SUMMARY

Generally, embodiments of this invention provide systems and methods for automatically aligning a die cutter relative to a web. According to a first preferred embodiment, a rotary die cutting system is provided that includes a die cutting roll having at least one blade thereon for cutting a web, and an indicator on the surface of the die cutting roll indicating the position of the at least one blade. The system further an anvil roll, spaced from the die cutting roll to define a web path therebetween. A drive mechanism drives the die cutting roll. A first sensor senses the indicator on the die cutting roll. A control, responsive to the first sensor, operates the drive mechanism to adjust the rotational position of the die cutting roll to align the die cutting roll relative to the web passing through the web path.

In some embodiments the die cutting roll may be a permanently adapted die cutting roll. In other embodiments the die cutting roll comprises a base roll, and a flexible die releasably mounted on the base roll, the at least one blade and the indicator being disposed on the flexible die. The flexible die may be releasably mounted on the base roll, for example by magnetic attraction.

In some embodiments, the position of the indicator on the flexible die indicates the position of the at least one cutting blade. In other embodiments, the position of the indicator on the flexible die and information contained on or in the indicator indicates the position of the at least one cutting blade on the flexible die. In some embodiments the first sensor can detect the orientation of the indicator on the flexible die, in which case the controller can operate an alarm if the detected orientation of the indicator varies from a desired orientation by more than a predetermined amount. Alternatively, correction means can be provided in the die cutting system for adjusting the skew of the die cutting roll to correct for minor misalignment of the flexible die on the base roll, and the control can operate the correction means to correct the skew indicated by the orientation of the first indicator on the flexible die.

The rotary die cutting system can further include a second sensor for sensing a second indicator on the web passing in the web path. This second indicator indicates the position of the printed images on the web. The control is preferably responsive to the first and second sensors, for operating the drive mechanism to adjust the rotational position of the die cutting roll to align the die cutting roll relative to the web passing through the web path.

### BRIEF DESCRIPTION OF THE DRAWINGS

FIG. 1 is a top plan view of a rotary die cutting system constructed according to the principles of this invention;

FIG. 2 is a front elevation view of the rotary die cutting system of FIG. 1;

FIG. 3 is a top plan view of a flexible die usable in the rotary die cutting machine shown in FIGS. 1 and 2; and

FIG. 4 is a top plan view of an alternative construction of a flexible die, showing an alternative placement of the indicators.

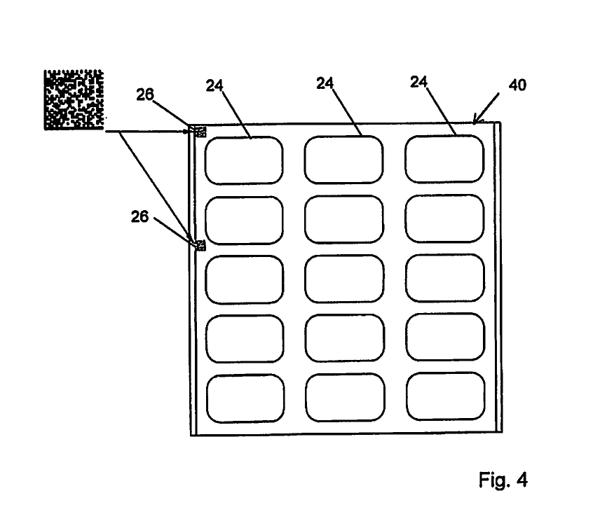

### DETAILED DESCRIPTION

Embodiments of this invention provide systems and methods for automatically aligning a die cutter relative to a web.

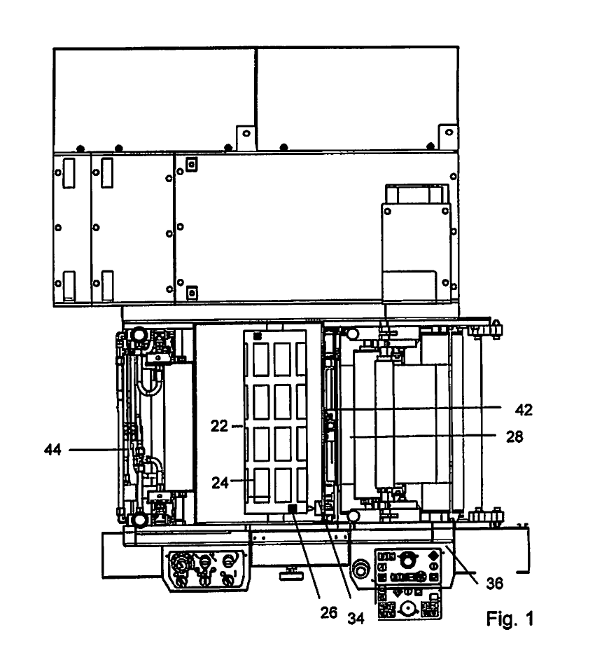

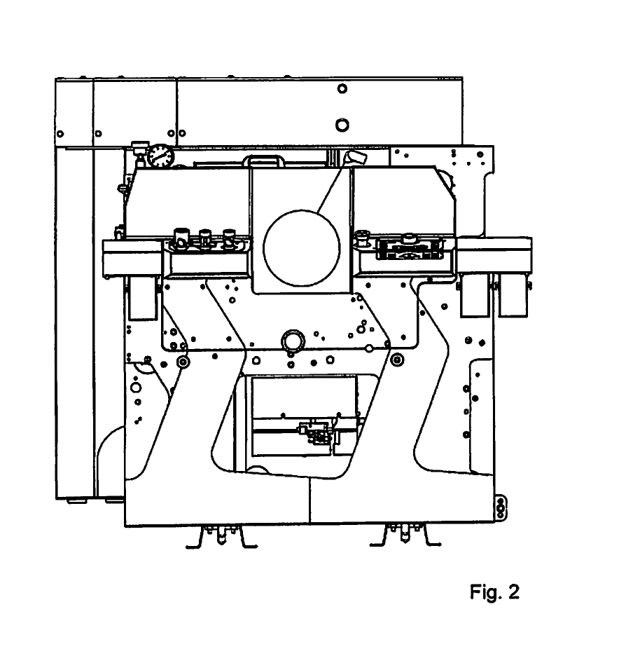

A first preferred embodiment of a rotary die cutting system is indicated generally as 20 in FIGS. 1 and 2. The die cutting system 20 comprises a die cutting roll 22 having at least one blade 24 thereon for cutting a web. There is an indicator 26 on the surface of the die cutting roll 22 for indicating the rotational position of the at least one blade 24 relative to the die cutting roll 22. The system 20 further comprises an anvil roll 28, spaced from the die cutting roll 22 to define a web path 30 therebetween. A drive mechanism 32 drives the die cutting roll 22. A first sensor 34 senses the position of the indicator 26 on the die cutting roll 22, and to the extent that the indicator has informational content, reads the content of the indicator. A control 36, responsive to the first sensor 34, operates the drive mechanism 32 to adjust the rotational position of the die cutting roll 22 to align the die cutting roll relative to the web passing through the web path 30.

In some embodiments the die cutting roll 22 may be a permanent or fixed die cutting roll, with at least one permanently mounted blade 24. In other embodiments the die cutting roll 22 may be a changeable die cutting roll, comprising a base roll 38, and a flexible die 40 releasably mounted on the base roll. The at least one blade 24 and the indicator 26 are disposed on the surface of the flexible die 40. The flexible die 40 may be releasably mounted on the base roll 38, for example by magnetic attraction. The base roll 38 can include at least one permanent magnet or electromagnet, and the flexible die can be made of a magnetically responsive material, such as steel, or it can include a portion made of a magnetic or magnetically responsive material.

In some embodiments, the position of the indicator 26 indicates the rotational position of the at least one blade 24 relative to the die cutting roll 22. In other embodiments, the position of the indicator 26 and information contained on or in the indicator indicates the rotational position of the at least one blade 34 relative to the die cutting roll 22. In some embodiments the first sensor 34 can detect the orientation of the indicator 26, in which case the controller 36 can operate an alarm if the detected orientation of the indicator varies from a desired orientation by more than a predetermined amount, indicating a skewed orientation of the die roll 22 or a skewed mounting of the flexible die 40 on the base roll 38. Alternatively, the rotary die cutting system 20 can include a correction mechanism for adjusting the skew of the die cutting roll 22 to correct for minor misalignment of the die roll 22 or for minor misalignment of the flexible die 40 on the base role 38 on the base roll, and the control 36 can operate the correction mechanism to correct the skew indicated by the orientation of the indicator 26.

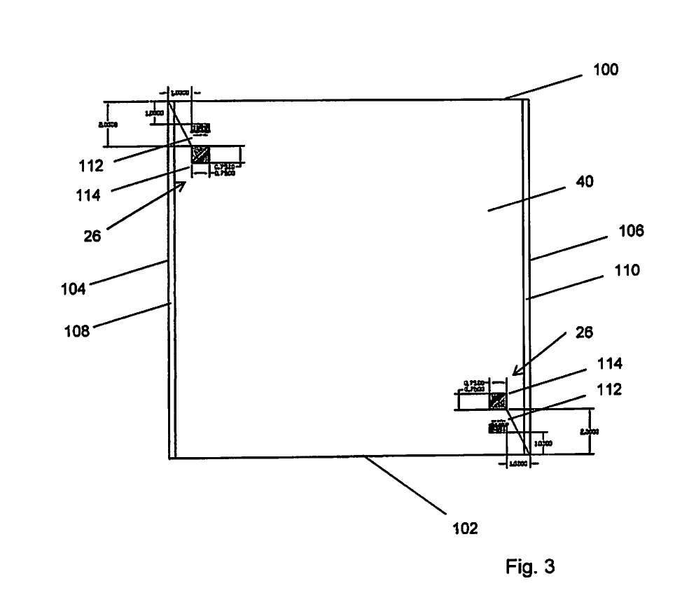

As shown in FIG. 3, the flexible die 40 comprises a generally rectangular flexible sheet, having forward and rearward edges 100 and 102, and left and right side edges 104 and 108. There is a gutter space 108 and 110 adjacent the left and right side edges 104 and 106, respectively, defining a field therebetween. The at least one indicator 26 is positioned somewhere on the field, preferably at a predefined position relative to the forward edge 100 and left edge 104, for example at one inch from the forward edge and one inch from the left edge. In this preferred embodiment there can be a second Indicator 26 positioned at a predefined position relative to the rearward edge 102 and right edge 106, for example at one inch from the rearward edge, and one inch from the right edge. Unless the flexible die 40 is symmetric, the indicators 26 at each edge are preferably different so that the sensor can also detect in which orientation the flexible has been mounted on the base roll 38.

As shown in FIG. 3, the indicator 26 can comprise a first symbol 112, which can be a decorative or trademark symbol, and whose position can indicate a position on the die roll 22 or on the flexible die on the base roll 36. The indicator 26 preferably further comprises a second informational symbol 114. The second informational symbol 114 can employ any known information encoding system to provide information to the die cutting system 20 relative to the die roll 22 or flexible die 40, for example a one dimensional bar code, a two-dimensional data matrix, or other optical encoding system. The indicator 26 can be a label or decal applied to the surface of blanket, but it is preferably printed or written by laser on the surface of the die roll 22 or the flexible die 40. Instead of an optically readable indicator, the indicator could be an RFID or some other type of indicator embedded in the die roll 22 or in the flexible die 40, but an optically readable indicator will usually be preferred because its position can be used to communicate information about the location of the at least one blade 24.

When an informational symbol is used, a wide variety of information can be provided on the blanket, including one or more of the following:

| INFORMATION | SIZE | | DESCRIPTION |
|---|---|---|---|
| Repeat | 3 | bits | The number of repeats (i.e., |
| | | | rows of cutting blades on the |
| | | | blanket) |
| Width | 3 | bits | The width (i.e., columns of |
| | | | cutting blades on the blanket) |
| Manufactured Date | 6 | bits | The date the blanket was |
| | | | manufactured |
| Customer ID | 4 | bits | The identification of the |
| | | | customer for the product made |
| | | | with the blanket |
| Manufacturer ID | 4 | bits | The identification of the user |
| | | | of the blanket |
| Pre-Reg Mark | 4 | bits | The location of the cutting |
| Location/Position | | | blades relative to the location |
| | | | of the symbol |
| Machine Pressure | 4 | bits | The designed/recommended |
| | | | cutting pressure for the blanket |
| Machine applied/ | 1 | bit | The designed/recommended |
| hand applied | | | end use for label |
| Cut Angle Type | 1 | bit | The designed angle of die cut |
| | | | blade |
| Clearance Target | 3 | bits | The designed clearance between |
| | | | the cutting and noncutting |
| | | | surfaces of the die |
| Stock Target | 2 | bits | The designed/recommended |
| | | | type of paper stock |
| Liner Thickness | 3 | bits | The designed/recommended |
| | | | thickness of the liner |
| Adhesive Type | 1 | bit | The designed/recommended |
| | | | adhesive type |
| Face Sheet | 1 | bit | The designed/recommended |
| | | | type of material on liner |
| Die Type | 1 | bit | The designed/recommended |
| | | | type of die (solid, flexible, etc) |
| Mark Revision | 2 | bits | The current revision of the |
| | | | marking algorithm |
| Maximum Speed | 4 | bits | The designed/recommended |
| | | | operating speed of the blanket |
| Die ID/Serial | 14 | bits | Unique ID number identifying |
| Number | | | the blanket |
| Magnetic Cylinder | 4 | bits | The type of base roll the blanket |
| Specification | | | is designed/recommended for |
| Units | 1 | bit | The units of measure in which |
| | | | the information is encoded |
| Reserved | 6 | bits | Space for future data additions |

The rotary die cutting system 20 can further include a second sensor (not shown) for sensing a second indicator (also not shown) on the web passing in the web path 30. The print indicator is in registration with the printed images on the web, and facilitates automatic alignment of the die cuts of the web with the printed images on the web. The control of the die cutting system 20 is preferably responsive to both first sensor 34 and the second sensor, for operating the drive mechanism 32 to adjust the rotational position of the die cutting roll to align the die cutting roll relative to the web passing through the web path 30.

In operation the die cutting roll 22 is disengaged from the anvil roll 28, and the drive mechanism 32 can be operated to turn the die cutting roll 22 to improve the alignment of the cuts made by the die cutting roll 22 with the images previously printed on the web. The drive mechanism 32 can either speed up or slow down the rotation of the die cutting roll 22 or even rotate the die cutting roll oppositely from the direction of travel of the web, to more quickly bring the cutting blades into alignment with the printed images and thereby reduce waste. The controller 36 can be programmed to determine how to control the die cutting roll to efficiently align the die cutting with the printed images.

A mechanism 42, powered by hydraulics 44 can translate the die cutting roll 22 partially out of engagement with the anvil roll 28 so that the die cutting roll can be rotated without affecting the web in the web path on the anvil roll.

The control 36 can be a simple microprocessor in a PLC or a more elaborate processor, such as a pc. The control 36 preferably also includes a memory for storing data regarding the die cutting roll 22 or the flexible die 40. For example, the indicator 26 can include information that uniquely identifies the die cutting roll 22 or the flexible die 40, and the control 36 can store information such as the number of cuts made by the die cutting roll 22 or the flexible die 40; the various adjustments and settings of the die cutting system made so that the cutting roll 22 or the flexible die 40 makes proper cuts. This allows the die cutting system 20 to quickly and automatically restore the appropriate settings, when the die cutting roll 22 or the flexible die 40 is subsequently reinstalled in the die cutting system 20. These adjustments can include position settings, pressure settings, speed settings, and the like. The indicator 26 can alternatively be replaced or rewritten so that information about the usage and appropriate settings for the die cutting roll 22 or flexible die 40 are carried with the die, Instead of, or in addition to the rotary die cutter.

What is claimed is:

1. A rotary die cutting system comprising:
a die cutting roll having at least one blade thereon for cutting a web, and an indicator on the surface of the die cutting roll indicating the position of the at least one blade;
an anvil roll, spaced from the die cutting roll to define a web path therebeween;
a drive mechanism for driving the die cutting roll;
a first sensor for sensing the indicator on the surface of the die cutting roll;
a control, responsive to the first sensor, for operating the drive mechanism to adjust the rotational position of the die cutting roll to align the die cutting roll relative to the web passing through the webpath.

2. The rotary die cutting system according to claim 1 wherein the die cutting roll comprises a base roll, and a blanket releasably mounted on the base roll, the at least one blade and the indicator being disposed on the blanket.

3. The rotary die cutting system according to claim 1 wherein the position of the indicator on the blanket indicates the position of the at least one cutting blade.

4. The rotary die cutting system according to claim 1 wherein the position of the indicator on the blanket, and Information contained in the indicator indicates the position of the at least one cutting blade.

5. The rotary die cutting system according to claim 1 further comprising a second sensor for sensing an indicator on the web passing in the web path; and wherein the control is responsive to the first and second sensors, for operating the drive mechanisms to adjust the rotational position of the die cutting roll to align the die cutting roll relative to the web passing through the webpath.

6. The rotary die cutting system according to claim 1 wherein the first sensor detects orientation of the indicator; wherein the controller operates an alarm of the detected orientation varies from a desired orientation by more than a predetermined amount

7. The rotary die cutting system according to claim 1 further comprising a correction mechanism for skewing the die roll, and wherein the first sensor detects orientation of the indicator; wherein the controller operates the skewing mechanism to correct the misorientation of the blanket indicated by the orientation of the indicator.
